(19) United States
(12) Patent Application Publication
(10) Pub. No.: US 2003/0179313 A1
(43) Pub. Date: Sep. 25, 2003

(54) Desktop video teleconferencing device combining an erasable writing-board & camera

(76) Inventor: Thomas Anthony Mormino SR., Staten Island, NY (US)

Correspondence Address: THOMAS A. MORMINO, SR., 85 WADSWORTH ROAD, STATEN ISLAND, NY, 10305, US

(21) Appl. No.: 10/063,096

(22) Filed: Mar. 19, 2002

(51) Int. Cl. H04N 5/225

(52) U.S. Cl. 348/373

(57) ABSTRACT

This device combines a video camera and erasable writing board as an entity. Since the camera and erasable board move together, the viewable area remains in focus during motion. The lightweight device is briefcase-transportable and may be used as a “Teleconferencing Pad” or “Video Scratch Pad”. The device accesses the WWW via a personal computer, laptop or other compatible electronic device. Freely available teleconferencing software is available on the WWW or may be packaged with the device. Several prototypes showing a webcam and erasable writing board (approximately 8.5″×11″), connected to a PC and laptop with a USB cable, are shown in FIGS. 1A and 1B.

### BRIEF DESCRIPTION OF DRAWINGS

FIG. 1A-prototype device with removable and adjustable camera bracket.

FIG. 1B-prototype with removable, flexible, adjustable gooseneck bracket.

FIG. 2A shows a Top View of the device.

FIG. 2B shows a Horizontal View of the device.

FIG. 3A shows a Front View of Universal camera-mount.

FIG. 3B shows a Horizontal View of Universal camera-mount.

### DETAILED DESCRIPTION

The Desktop Video Teleconferencing erasable writing-board & camera device, combines the technology of a video camera, such as a webcam, with that of an erasable surface such as a white, green or blackboard surface. The portable and light-weight device consists of a video camera mounted on an erasable board. Camera (with optional integrated microphone and centering light-beam) and board are connected via a flexible gooseneck or a rigid but adjustable bracket. Camera and mount are removable for transportability. The device utilizes existing PC teleconferencing software systems to conduct Video/Audio/Data teleconferencing sessions globally. Camera and board move as an entity so that hand-written information, sketches, images etc., remain in focus. Camera may be shifted over the board to project different “information themes” in real-time. The board optionally contains a graphing section for the real-time sketching of information such as business or social trends, design specifications, medical results, mathematical and scientific relationships, as examples.

1 the device combines an erasable writing-board and a video camera:

2 As in claim c1, camera is mounted to the writing-board with a flexible gooseneck or rigid bracket, adjustable in height above the writing-board and relative to the surface of the writing-board.

3 As in claim c1 and c2, board and camera move as an entity so that images, objects, handwritten information etc., remain in focus during movement of the device.

4 As in claim c1, the video camera connects to the Internet/WWW or other network by way of a computer or other compatible electronic device.

5 As in claim c1 and claim c4, camera may utilize teleconferencing software packaged with the device or freely available on the WWW.

6 As in claim c2, the mounts may be removable for transportability.

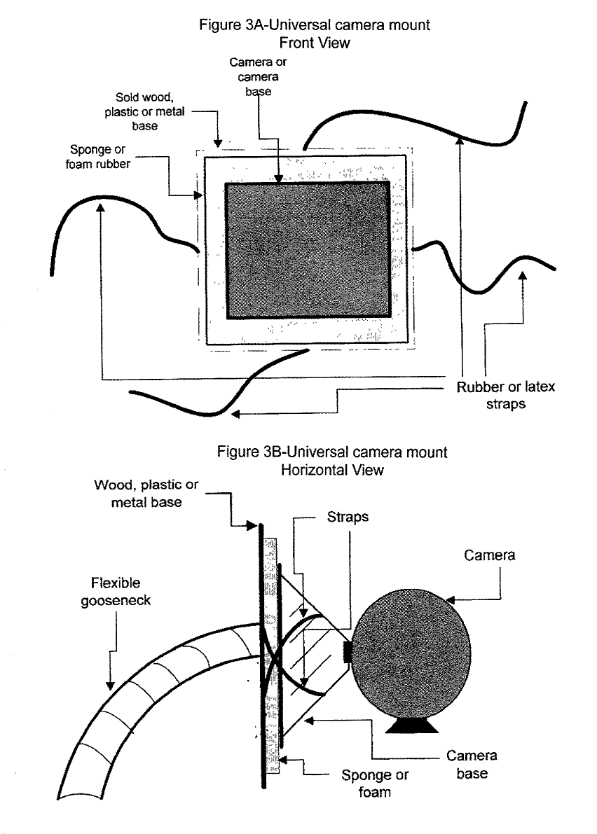

7 As in claims c1 and c2, the erasable writing-board may include a universal adapter shown in FIGS. 3A and 3B which allow for mounting of OEM cameras.

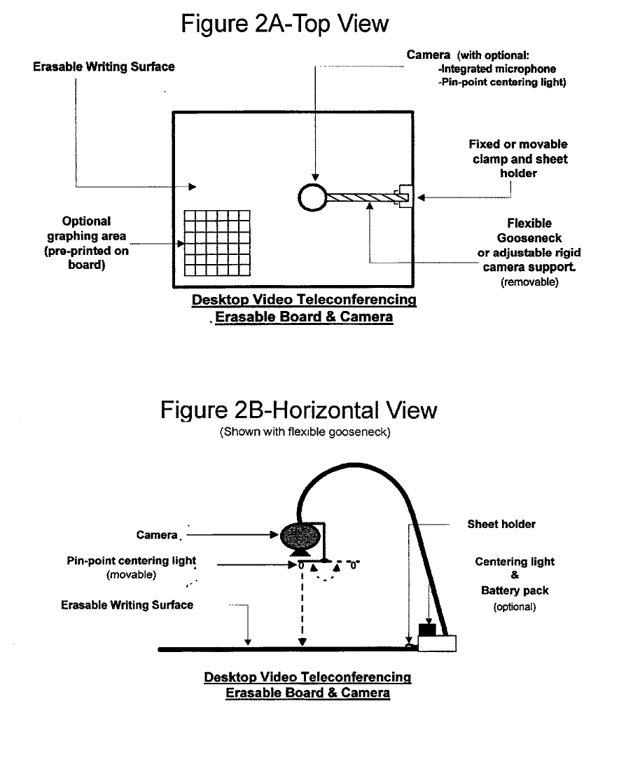

8 As in claim c1, device may include an optional centering light using a battery pack shown in FIG. 2B or connected to a computer.

9 As in claim c1, device may include an optional sheet holding clamp shown in FIG. 2B.

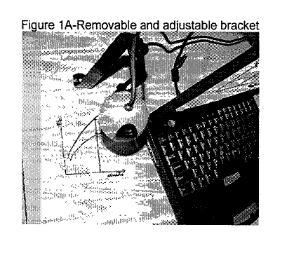

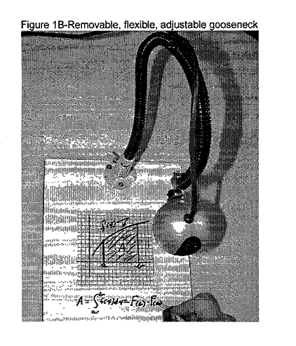

10 As in claim c1, erasable writing-board may include pre-printed graphing templates as shown in FIGS. 1B and 2A.
